(19) United States
(12) Patent Application Publication
(10) Pub. No.: US 2011/0004597 A1
(43) Pub. Date: Jan. 6, 2011

(54) SYSTEM AND METHOD FOR CONTENT AWARE ROUTING OF DATA WITHIN A PLATFORM HUB

(76) Inventors: Yehiel ENGEL, Moshav Zerofa (IL); Avraham Ganor, Shoham (IL); Gal Gilat, Tel-Aviv (IL); Michael Chaim Schnarch, Or-Yehuda (IL)

Correspondence Address: Pearl Cohen Zedek Latzer, LLP, 1500 Broadway, 12th Floor, New York, NY, 10036, US

(21) Appl. No.: 12/725,210

(22) Filed: Mar. 16, 2010

Related U.S. Application Data
(60) Provisional application No. 61/160,383, filed on Mar. 16, 2009.

(51) Int. Cl. G06F 15/173; G06F 17/30

(52) U.S. Cl. 707/741; 709/238; 707/E17.002

(57) ABSTRACT

A method, system and platform hub for content aware routing of data, the platform hub comprising: a processor port for bidirectional data communication with a processing platform; at least one network ports for bidirectional data communication with at least one corresponding network agents; and at least one content aware units configured for performing content aware classification of data incoming into the platform hub, wherein the platform hub is configured for routing data to a suitable destination based on the content aware classification. The method for content aware routing of data comprises: receiving in a platform hub a data packet sent from a network towards a processing platform; performing a content aware classification in the platform hub; and routing the data packet based on the content aware classification.

### CROSS REFERENCE TO RELATED APPLICATIONS

This application claims the benefit of U.S. Provisional Application No. 61/160,383, filed on Mar. 16, 2009, which is incorporated in its entirety herein by reference.

### BACKGROUND OF THE INVENTION

In current network configurations, when data from the network arrives to a server, the server processor(s) usually receive all the data incoming from the network, for example in order to perform classification of the data and direct the data to its final destination or to further processing in the host server. In most cases, a major portion of the data is directed by the server processor(s) to another destination such as, for example, to a network agent or to a storage device. This may cause many redundant round trips of data packets from the network to the processor and back. In most cases only a small portion of the data needs to be further handled in the host server. Receiving all the data in the host server and the need to classify all the data in the host server may increase the processor utilization, increase cache pollution, increase power consumption and increase other computational tasks latency.

In addition, in cases when the server is a multi-processor server and/or includes a multi-core processor, the data may arrive to the wrong processor/core. This may also cause poor performamce, for example due to cache pollution and the need to move the data packet from one core to another.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a system for routing data according to some embodiments of the present invention;

FIG. 2 is a schematic illustration of a system for routing data according to some embodiments of the present invention;

FIG. 3 is a schematic illustration of a system for cascaded routing of data according to some embodiments of the present invention;

FIG. 4 is a schematic illustration of a system for routing data according to some other embodiments of the present invention; and

FIG. 5 is a flowchart illustrating a method for routing data according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Embodiments of the present invention may provide system and method for content aware routing of data within a platform hub. The platform hub may be connected by a duplex port to a processing platform (for example, a server). All the data which is sent towards the processing platform or outwards from the processing platform may pass through the platform hub. The platform hub may include several network ports for bidirectional communication with network agents. The platform hub may include one or more content aware unit(s) which may perform classification of the data which passes through the platform hub and route the data to a suitable destination based on the classification. As a result of the classification and routing at the platform hub, fewer data packets may be sent to the processor(s) of the processing platform, fewer classification tasks need to be performed by the processor(s), fewer round trips of data packets from the network to the processor(s) and back are caused, and data packets which are routed by the platform hub towards the processing platform may be directed based on the classification to the suitable processor/core in the processing platform. Therefore, embodiments of the present invention may improve the performance of the processing platform and reduce the consumed power.

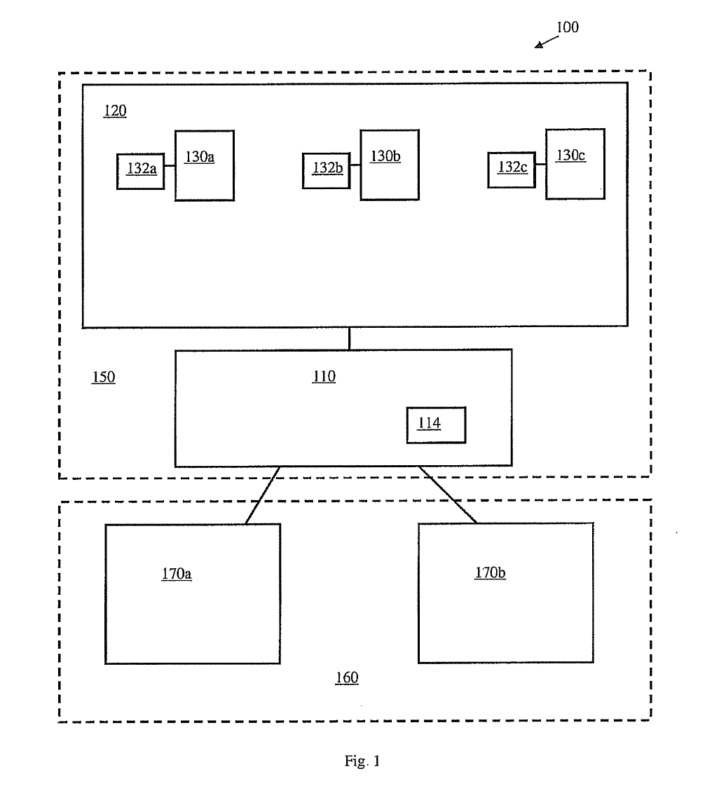

Reference is now made to FIG. 1, which is a schematic illustration of a system 100 for routing data according to some embodiments of the present invention. System 100 may include a processing platform 120 and a platform hub 110 which may include a Content Aware Unit (CAU) 114. Processing platform 120 may include any kind of a server, multiprocessor, and/or processor(s). For example, processing platform 120 may include processors 130a, 130b and 130c. However, processing platform 120 may include any suitable number of processors and the present invention is not limited in this respect. In some embodiments, each processor may include one or more cores (not shown) which may operate in parallel, for example, as in a multi-core processor. In some embodiments, each processor may be connected to or include a proximate local memory 132a, 132b or 132c, respectively, for example when a Non-Uniform Memory Access (NUMA) design is used. Processing platform 120 may be connected to platform hub 110 through a connection port (not shown). In some embodiments, processing platform 120 and platform hub 110 may be cased together in a case 150. However, in other embodiments of the present invention, platform 120 and platform hub 110 may not be cased together.

Platform hub 110 may include several network ports (not shown) which may enable connection to communication mediums of a network 160, for example, network agents 170a and 170b. Network 160 may include Local Area Network (LAN), Wide Area Network (WAN), or any other suitable type of communication network. Network agents 170a and 170b may include, for example, network communication channels or any suitable network entity, medium or agent available. Although FIG. 1 shows two network agents 170a and 170b, any suitable number of network agents of network 160 may be connected to network ports of platform hub 110 and the present invention is not limited in this respect.

Network agent 170a and/or 170b may send data packets toward processing platform 120. Data packets which are sent from network 160 towards processing platform 120 may be received through platform hub 110. Data packets which may be sent from processing platform 120 towards network 160 may also pass through platform hub 110.

CAU 114 may classify the data packets according to the content of the packets. Based on the classification, CAU 114 may send the data packets to processing platform 120 or to network 160. Additionally, based on the classification, CAU 114 may send the data packets to specific processors and/or cores in processing platform 120, or to specific network agents in network 160. The classification by CAU 114 may be performed based on the content of the packet header portion and/or based on the content of the packet data portion. The classification type performed by CAU 114 may be predefined by a user.

The following are examples of classifications types which can be made by CAU 114. However, the present invention is not limited to the classification types indicated in the examples. For example, the classification may be made based on packet specific information such as, for example, source IP for IP packets or media access control (MAC) address for Ethernet packets. For example, the classification may be made based on size of the data packet. For example, the classification may be made based on type of data in the data packet, e.g. whether the data is image, sound, text, tables, commands, etc. For example, the classification may be made based on the packet type, e.g. based on the transport protocol being used, such as, for example, User Datagram Protocol (UDP) or Transmission Control Protocol (TCP) or Stream Control Transmission Protocol (SCTP) or any other suitable transport protocol.

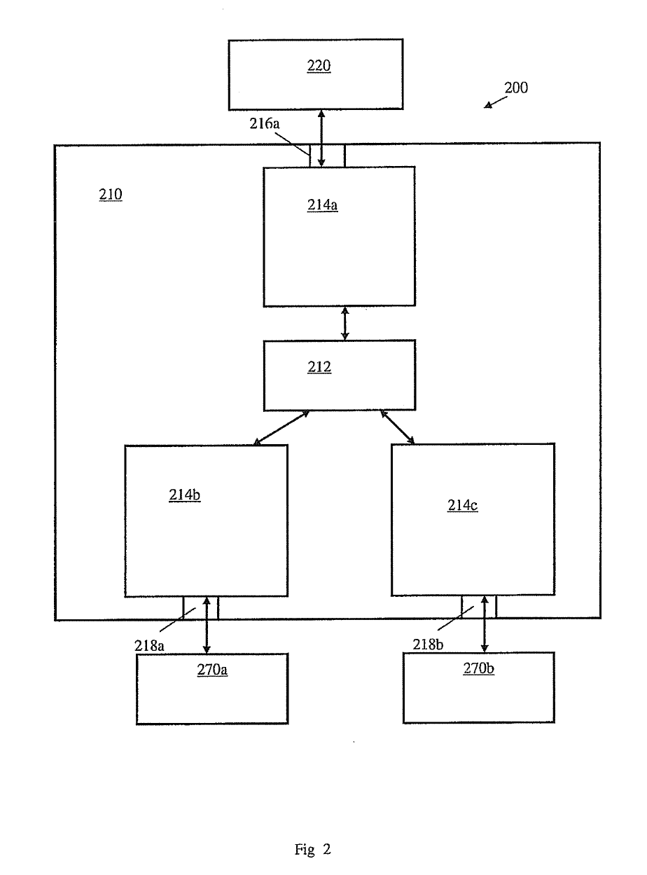

Reference is now made to FIG. 2, which is a schematic illustration of a system 200 for routing data according to some embodiments of the present invention. System 200 may include platform hub 210, a processing platform 220 and network agents 270a and 270b. Platform hub 210 may be a more detailed embodiment of platform hub 110 described above with reference to FIG. 1. Platform hub 210 may include a processor port 216a for connection and/or bidirectional data communication with processing platform 220 to platform hub 210. Platform hub 210 may include network ports 218a and 218b for connection and/or bidirectional data communication with network agents 270a and 270b, respectively, to platform hub 210. Platform hub 210 may include any other suitable number of network ports and may connect to and/or perform bidirectional data communication with a respective number of network agents. Platform hub 210 may include a Content Aware Unit (CAU) at each port of platform hub 210. For example, platform hub 210 may include CAU 214a at processor port 216a, CAU 214b at network port 218a and CAU 214c at network port 218b. Additionally, Platform hub 210 may include an interconnection unit 212 through which data packets may be routed according to the classification by CAUs 214a, 214b and/or 214c.

When a data packet is received from network agent 270a or 270b or from processing platform 220, the respective CAU may classify the data packet. Based on the classification, platform hub 210 may route the data packet to processing platform 220, for example to a suitable processor/core in processing platform 220, or to a suitable network agent.

In some embodiments of the present invention, based on the classification the CAU may generate an index vector which may point to an entry of a lookup table. An entry of the lookup table may include routing information such as indication of a destination port. In case the destination port is processor port 216a, the entry of the lookup table may additionally include the indication of destination processor/core within processing platform 220, for example in case processing platform 220 is a multi-processor and/or multi-core platform. In case the destination entity uses priority queue mechanism, for example for determination of the order in which data packets are received and/or processed, the entry of the lookup table may additionally include indication of the destination queue. Any other suitable routing information may be included in an entry of the lookup table. It will be appreciated by those skilled in the art that mechanisms other than lookup table may be used for storing routing information and making it available as described above. Based on the routing information in the entry pointed to by the index vector, platform hub 210 may route the data packet to the suitable destination through interconnection unit 212.

For example, it may be decided, for example by a user, that processing platform 220 should handle certain types of data packets and that other incoming packets should be sent back to the network. A type of a data packet may include, for example, a type of transport protocol being used, data packet size, type of data, or any other suitable kind of classification criteria. CAUs 214a, 214b and 214c may detect the data packet of a desired type based on the content aware classification. For data packets of the desired type incoming from network ports 218a and/or 218b, CAUs 214b and/or 214c may be pre-configured to generate an index vector routing the data packet to processor port 216a as a destination port. For data packets which are not of the desired type, CAUs 214b and/or 214c may be pre-configured to generate an index vector routing the data packet to the suitable network port, for example network port 218a or 218b.

In some cases, platform hub 210 may be used to filter out certain kinds of data packets and/or data packets which include certain kinds of content. For example, CAU 214a, 214b or 214c may detect, based on the content aware classification, that the data packet should be discarded, for example according to pre-configuration of the CAU by a user. Platform hub 210 may filter out the unwanted data packet, for example, by routing the data packet to an unconnected or a nonexistent port. For example, the CAU which detects an unwanted data packet may generate an index vector pointing to a lookup table entry which may define the destination to be an unconnected or a nonexistent port.

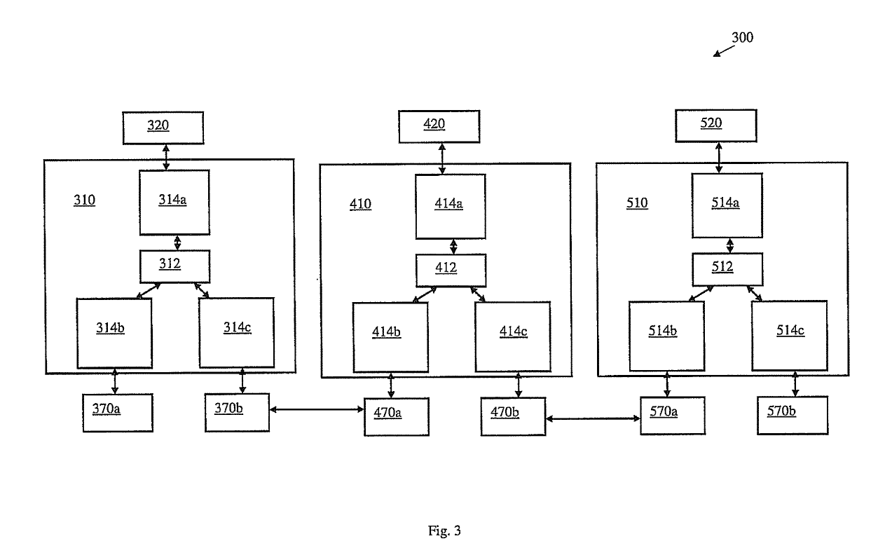

In some embodiments of the present invention, a series of platform hubs, wherein each platform hub may be connected to a corresponding processing platform, may be used for cascaded routing of data, as described in detail herein below with reference to FIG. 3.

Reference is now made to FIG. 3, which is a schematic illustration of a system 300 for cascaded routing of data according to some embodiments of the present invention. System 300 may include plurality of platform hubs 310, 410 and 510 which may be similar to platform hub 210 described above with reference to FIG. 2. Platform hubs 310, 410 and 510 may be connected to corresponding processing platforms 320, 420 and 520 and to corresponding network agents 370a and 370b, 470a and 470b, and 570a and 570b. Platform hubs 310, 410 and 510 may include a Content Aware Unit (CAU) at each port connecting them to processing platform or to network agent, as described above in details with reference to Platform hub 210 and shown in FIG. 2. Accordingly, platform hub 310 may include CAU 314a, CAU 314b and CAU 314c, platform hub 410 may include CAU 414a, CAU 414b and CAU 414c, and platform hub 510 may include CAU 514a, CAU 514b and CAU 514c. Additionally, Platform hub 310 may include an interconnection unit 312 through which data packets may be routed according to the classification by CAUs 314a, 314b and/or 314c. Similarly, Platform hub 410 may include an interconnection unit 412 and platform hub 510 may include an interconnection unit 512. Although in FIG. 3 system 300 is shown to include three platform hubs and corresponding three processing platforms, system 300 may include any other suitable number of platform hubs and corresponding processing platforms.

It may be decided, for example, by a user, that processing platform 320 should handle data packets of type “A”, that processing platform 420 should handle data packets of type “B” and that processing platform 520 should handle data packets of type “C”. When a data packet is received in platform hub 310 from a network agent, for example network agent 370a, CAU 314b may detect based on the content aware classification whether the data packet is of type “A”. In cased the data packet is of type “A”, platform hub 310 may route the data packet to processing platform 320, for example, in the manner described above with reference to FIG. 2. In case the data packet is not of type “A”, platform hub 310 may route the data packet to another network agent, for example network agent 370b. In some cases CAU 314b may detect that the data packet should be filtered out of the system or should be sent to another port and thus, for example, platform hub 310 may discard the data packet or route it to another port, respectively, for example in the manners described above with reference to FIG. 2.

A data packet which is routed to network agent 370b may subsequently be received in platform hub 410 through network agent 470a. CAU 414b may detect, based on the content aware classification, whether the data packet is of type “B”. In cased the data packet is of type “B”, platform hub 410 may route the data packet to processing platform 420, for example, in the manner described above with reference to FIG. 2. In case the data packet is not of type “B”, platform hub 410 may route the data packet to another network agent, for example network agent 470b. In some cases CAU 414b may detect that the data packet should be filtered out of the system or should be sent to another port and thus, for example, platform hub 410 may discard the data packet or route it to another port, respectively, for example in the manners described above with reference to FIG. 2.

A data packet which is routed to network agent 470b may subsequently be received in platform hub 510 through network agent 570a. CAU 514b may detect based on the content aware classification whether the data packet is of type “C”. In cased the data packet is of type “C”, platform hub 510 may route the data packet to processing platform 520, for example, in the manner described above with reference to FIG. 2. In case the data packet is not of type “C”, platform hub 510 may route the data packet to another network agent, for example network agent 570b. In some cases CAU 514b may detect that the data packet should be filtered out of the system or should be sent to another port and thus, for example, platform hub 510 may discard the data packet or route it to another port, respectively, for example in the manners described above with reference to FIG. 2.

The process described above may continue similarly with additional platform hubs and corresponding processing platforms.

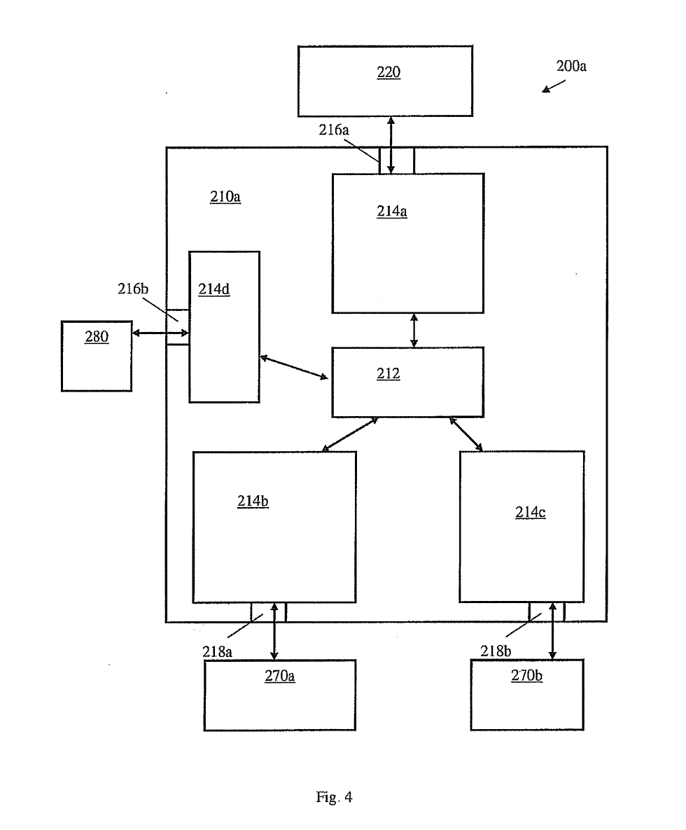

Reference is now made to FIG. 4, which is a schematic illustration of a system 200a for routing data according to some other embodiments of the present invention. In FIG. 4 similar elements are notated with the same referral numbers as in FIG. 2. System 200a may include a platform hub 210a, which may include additional ports and CAUs, for example a port 216b which may be accompanied with a CAU 214d. Port 216b may enable, for example, connection to a storage device 280, such as a disk, hard-disk, disk-on-key or any other suitable kind of a data storage device. Platform hub 210a may fetch data directly from storage device 280 without intervention of a processor, and send it to the suitable port based on the content aware classification by CAU 214d. Additionally, data received from processing platform 220 or from network agent 270a or 270b may be routed to storage device 280 for storage.

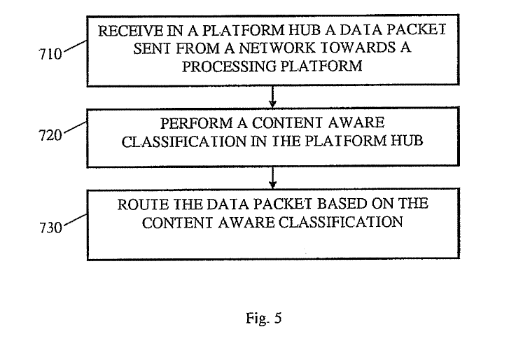

Reference is now made to FIG. 5, which is a flowchart illustrating a method for routing data according to some embodiments of the present invention. As indicated in block 710, the method may include receiving in a platform hub a data packet sent from a network towards a processing platform. As indicated in block 720, the method may include performing a content aware classification in the platform hub, for example by a CAU as described above with reference to FIGS. 1-3. As indicated in block 730, the method may include routing the data packet based on the content aware classification, for example as described above with reference to FIGS. 1-3.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A platform hub for content aware routing of data, the platform hub comprising:
a processor port for bidirectional data communication with a processing platform;
at least one network ports for bidirectional data communication with at least one corresponding network agents; and
at least one content aware units configured for performing content aware classification of data incoming into said platform hub,
wherein said platform hub is configured for routing data to a suitable destination based on the content aware classification.

2. A platform hub according to claim 1, wherein each of said at least one content aware units is configured for performing content aware classification of data incoming from a respective one of said at least one network ports or said processor port.

3. A platform hub according to claim 1, wherein said at least one content aware units are configured for generating an index vector based on the content aware classification, said index vector point to a lookup table entry comprising routing information, and wherein said platform hub is configured for routing data to a suitable destination based on said routing information.

4. A platform hub according to claim 3, wherein said routing information comprises at least one of a list comprising: a destination port, a destination processor, a destination core and a destination queue.

5. A system for content aware routing of data, the system comprising:
a processing platform; and
a platform hub comprising:
a processor port for bidirectional data communication with said processing platform;
at least one network ports for bidirectional data communication with at least one corresponding network agents; and
at least one content aware units configured for performing content aware classification of data incoming into said platform hub,
wherein said platform hub is configured for routing data to a suitable destination based on the content aware classification.

6. A system according to claim 5, wherein said processing platform and platform hub are cased together.

7. A system according to claim 5, wherein said processing platform comprises at least one of a multi-processor and a multi-core processor.

8. A system according to claim 5, wherein each of said at least one content aware units is configured for performing content aware classification of data incoming from a respective one of said at least one network ports or said processor port.

9. A system according to claim 5, wherein said at least one content aware units are configured for generating an index vector based on the content aware classification, said index vector point to a lookup table entry comprising routing information, and wherein said platform hub is configured for routing data to a suitable destination based on said routing information.

10. A system according to claim 9, wherein said routing information comprises at least one of a list comprising: a destination port, a destination processor in a multi-processor processing platform, a destination core in a multi-core processor and a destination queue.

11. A method for content aware routing of data, the method comprising:
receiving in a platform hub a data packet sent from a network towards a processing platform;
performing a content aware classification in the platform hub; and
routing the data packet based on the content aware classification.

12. A method according to claim 11, wherein the content aware classification is performed by at least one content aware unit comprised in said platform hub.

13. A method according to claim 12, wherein said content aware classification is performed at each of said at least one content aware unit for data incoming from a respective one of a network port or a processor port of said platform hub.

14. A method according to claim 11, further comprising generating an index vector based on the content aware classification, said index vector point to a lookup table entry comprising routing information, and wherein said platform hub is configured for routing data to a suitable destination based on said routing information.
